(19) United States
(12) Patent Application Publication
(10) Pub. No.: US 2026/0252911 A1
(43) Pub. Date: Aug. 27, 2026

(54) METHOD AND ELECTRONIC DEVICE FOR OPTIMIZING MIXTURE OF EXPERTS MODEL

(71) Applicant: D.notitia Inc., Seoul (KR)

(72) Inventors: Seungjae Lee, Seoul (KR); Doohyun Cho, Seoul (KR)

(21) Appl. No.: 19/210,459

(22) Filed: May 16, 2025

(30) Foreign Application Priority Data
Feb. 26, 2025 (KR) 10-2025-0025159

(51) Int. Cl. G06N 5/022

(52) U.S. Cl. CPC G06N 5/022

(57) ABSTRACT

A method for optimizing a mixture of experts model, performed by at least one processor, includes acquiring a hidden state of a first layer, acquiring an index of at least one second layer following the first layer, predicting, based on the hidden state of the first layer and the index of the at least one second layer, at least one first expert unit to be activated in the at least one second layer, and prefetching the predicted at least one first expert unit.

### CROSS-REFERENCE TO RELATED APPLICATION

This application claims priority to Korean Patent Application No. 10-2025-0025159, filed in the Korean Intellectual Property Office on Feb. 26, 2025, the entire contents of which are hereby incorporated by reference.

### BACKGROUND

### Field

The present disclosure relates to a method for optimizing a mixture of experts model and an electronic device.

### Description of Related Art

In order to improve the performance of large language models (LLMs), a mixture of experts (MoE) structure can be used. A mixture of experts model includes multiple expert networks and may expand the capacity and performance of the model by selecting an appropriate expert according to the input and performing the computation.

Such a mixture of experts model may select an expert to be activated by using an independent routing network for each layer. However, although the routing network allows each layer to select an optimal expert, because the routing network operates independently at each layer, additional computational overhead may occur during the inference process. In addition, overhead may be large in the process of loading to memory the expert selected at each layer. In particular, in order to implement a mixture of experts model in a single chip, not only the routing network but also the weight of the expert network are loaded, so high-bandwidth memory may be required. In order to address this, attempts have been made to use technologies such as prefetch, but in the existing mixture of experts model, because an expert is selected only at the current layer without considering which expert will be used at the next layer, advance planning for efficient expert prefetch may be impossible. Accordingly, the development of a technology for efficient expert prefetch is required.

### SUMMARY

The present disclosure provides a method for optimizing a mixture of experts model and an electronic device in order to solve the above-described issues.

The present disclosure may be implemented in various forms, including a method, a device (system), and/or a non-transitory computer-readable recording medium on which instructions executable by a computer are recorded.

In some implementations, a method for optimizing a mixture of experts model, performed by at least one processor, may include acquiring a hidden state of a first layer, acquiring an index of at least one second layer following the first layer, predicting, based on the hidden state of the first layer and the index of the at least one second layer, at least one first expert unit to be activated in the at least one second layer, and prefetching the predicted at least one first expert unit.

In some implementations, the method may include acquiring a hidden state of a third layer, which is a last layer among the at least one second layer, acquiring an index of at least one fourth layer following the third layer, predicting, based on the hidden state of the third layer and the index of the at least one fourth layer, at least one second expert unit to be activated in the at least one fourth layer, and prefetching the predicted at least one second expert unit.

In some implementations, the method further includes setting, based on a structure of the mixture of experts model, a number of the at least one second layer and a number of the at least one first expert unit.

In some implementations, predicting the at least one first expert unit may include predicting the at least one first expert unit using a neural network model.

In some implementations, the method further includes acquiring a hidden state of the at least one second layer, selecting, based on the hidden state of the at least one second layer, at least one third expert unit that is activated in the at least one second layer, and if a certain expert unit different from the at least one first expert unit is identified among the at least one third expert unit, loading the certain expert unit.

In some implementations, predicting the at least one first expert unit is performed by an integrated routing module implemented on hardware separate from hardware on which the mixture of experts model is implemented.

In some implementations, the method further includes acquiring a hidden state of the at least one second layer, selecting, based on the hidden state of the at least one second layer, at least one third expert unit that is activated in the at least one second layer, and training a neural network model for predicting the at least one first expert unit using a selection result of the at least one third expert unit.

In some implementations, a non-transitory computer-readable recording medium storing computer-readable instructions that, when executed by at least one processor, cause the at least one processor to acquire a hidden state of a first layer, acquire an index of at least one second layer following the first layer, predict, based on the hidden state of the first layer and the index of the at least one second layer, at least one first expert unit to be activated in the at least one second layer, and prefetch the predicted at least one first expert unit.

In some implementations, an electronic device may include a mixture of experts model may include a plurality of expert units performing neural network operations, a routing unit configured to select at least one expert unit suitable for a particular neural network operation among the plurality of expert units, and an internal memory, and an integrated routing module configured to acquire a hidden state of a first layer of the mixture of experts model, acquire an index of at least one second layer following the first layer, predict, based on the hidden state of the first layer and the index of the at least one second layer, at least one first expert unit to be activated in the at least one second layer, and prefetch the predicted at least one first expert unit into the internal memory.

In some implementations, the integrated routing module is configured to acquire a hidden state of a third layer, which is a last layer among the at least one second layer, acquire an index of at least one fourth layer following the third layer, predict, based on the hidden state of the third layer and the index of the at least one fourth layer, at least one second expert unit to be activated in the at least one fourth layer, and prefetch the predicted at least one second expert unit into the internal memory.

In some implementations, the integrated routing module is configured to set a number of the at least one second layer and a number of the at least one first expert unit based on a structure of the mixture of experts model.

In some implementations, the integrated routing module includes a neural network model for predicting the at least one first expert unit.

In some implementations, the routing unit is configured to acquire a hidden state of the at least one second layer, select, based on the hidden state of the at least one second layer, at least one third expert unit that is activated in the at least one second layer, and if a certain expert unit different from the at least one first expert unit is identified among the at least one third expert unit, load the certain expert unit into the internal memory.

In some implementations, the integrated routing module is implemented on hardware separate from hardware on which the mixture of experts model is implemented.

In some implementations, the routing unit is configured to acquire a hidden state of the at least one second layer, and select, based on the hidden state of the at least one second layer, at least one third expert unit that is activated in the at least one second layer, and wherein the integrated routing module is configured to train a neural network model for predicting the at least one first expert unit using a selection result of the at least one third expert unit.

According to some aspects of the present disclosure, by predicting at least one expert unit to be activated in at least one subsequent layer in advance through an integrated routing module and prefetching the predicted expert unit, it is possible to reduce the overhead of loading expert units, reduce memory access time, and improve inference speed.

Further, according to some aspects of the present disclosure, by selecting expert units through a single integrated routing module, the consistency of expert selection may be increased, thereby improving the quality of inference results.

Further, according to some aspects of the present disclosure, by predicting and pre-loading in advance an expert unit needed for the next step, memory usage may be optimized, and resource efficiency may be increased.

Further, according to some aspects of the present disclosure, the number of layers to be predicted and the number of expert units may be adjusted so as to be flexibly applied to various structures of mixture of experts models.

Further, according to some aspects of the present disclosure, by precomputing in advance, on hardware independent of the main network of the mixture of experts model, an expert unit for prefetch regardless of the compute/memory bounds of the main network, it is possible to utilize resources more efficiently.

Further, according to some aspects of the present disclosure, the prediction performance of the integrated routing module may improve the more the mixture of experts model is used through online training, thereby leading to an improvement in prefetch performance.

The effects of the present disclosure are not limited to those mentioned above, and other effects not mentioned herein will be clearly understood by those of ordinary skill in the art to which this disclosure pertains from the description of the claims.

### BRIEF DESCRIPTION OF THE DRAWINGS

Embodiment(s) of the present disclosure will be described below with reference to the accompanying drawings, in which like reference numerals represent like elements, but are not limited thereto.

FIG. 1 illustrates an electronic device for optimizing a mixture of experts model according to an example of the present disclosure.

FIG. 2 is a diagram illustrating a configuration of the electronic device according to an example of the present disclosure.

FIG. 3 is a conceptual diagram illustrating a mixture of experts model according to an example of the present disclosure.

FIG. 4 is a diagram illustrating a configuration of a mixture of experts model according to an example of the present disclosure.

FIG. 5 is a diagram illustrating a configuration of an integrated routing module according to an example of the present disclosure.

FIG. 6 is a conceptual diagram illustrating a mixture of experts model and an integrated routing module according to an example of the present disclosure.

FIG. 7 is a diagram illustrating a method for optimizing a mixture of experts model according to an example of the present disclosure.

### DETAILED DESCRIPTION

Hereinafter, example details for the practice of the present disclosure will be described in detail with reference to the accompanying drawings. However, in the following description, detailed descriptions of well-known functions or configurations will be omitted if it may make the subject matter of the present disclosure rather unclear.

In the accompanying drawings, the same or corresponding components are assigned the same reference numerals. In addition, in the following description of various examples, duplicate descriptions of the same or corresponding components may be omitted. However, even if descriptions of components are omitted, it is not intended that such components are not included in any example.

Advantages and features of the disclosed examples and methods of accomplishing the same will be apparent by referring to examples described below in connection with the accompanying drawings. However, the present disclosure is not limited to the examples disclosed below, and may be implemented in various forms different from each other, and the examples are merely provided to make the present disclosure complete, and to fully disclose the scope of the disclosure to those skilled in the art to which the present disclosure pertains.

The terms used herein will be briefly described prior to describing the disclosed example(s) in detail. The terms used herein have been selected as general terms which are widely used at present in consideration of the functions of the present disclosure, and this may be altered according to the intent of an operator skilled in the art, related practice, or introduction of new technology. In addition, in specific cases, certain terms may be arbitrarily selected by the applicant, and the meaning of the terms will be described in detail in a corresponding description of the example(s). Accordingly, the terms used in this disclosure should be defined based on the meaning of the term and the overall content of the present disclosure, rather than simply the name of the term.

As used herein, the singular forms “a,” “an,” and “the” are intended to include the plural forms as well, unless the context clearly indicates the singular forms. Further, the plural forms are intended to include the singular forms as well, unless the context clearly indicates the plural forms. Further, throughout the description, when a portion is stated as “comprising (including)” a component, it is intended as meaning that the portion may additionally comprise (or include or have) another component, rather than excluding the same, unless specified to the contrary.

Further, the term “module” or “unit” used herein refers to a software or hardware component, and “module” or “unit” performs certain roles. However, the meaning of the “module” or “unit” is not limited to software or hardware. The “module” or “unit” may be configured to be in an addressable storage medium or configured to play one or more processors. Accordingly, as an example, the “module” or “unit” may include components such as software components, object-oriented software components, class components, and task components, and at least one of processes, functions, attributes, procedures, subroutines, program code segments, drivers, firmware, micro-codes, circuits, data, database, data structures, tables, arrays, and variables. Furthermore, functions provided in the components and the “modules” or “units” may be combined into a smaller number of components and “modules” or “units”, or further divided into additional components and “modules” or “units.”

A “module” or “unit” may be implemented as a processor and a memory, or may be implemented as a circuit (circuitry). Terms such as circuit and circuitry may refer to circuits in hardware, but may also refer to circuits in software. The “processor” should be interpreted broadly to encompass a general-purpose processor, a central processing unit (CPU), a microprocessor, a digital signal processor (DSP), a neural processing unit (NPU), a controller, a microcontroller, a state machine, etc. Under some circumstances, the “processor” may refer to an application-specific integrated circuit (ASIC), a programmable logic device (PLD), a field-programmable gate array (FPGA), etc. The “processor” may refer to a combination for processing devices, e.g., a combination of a DSP and a microprocessor, a combination of a plurality of microprocessors, a combination of one or more microprocessors in conjunction with a DSP core, or any other combination of such configurations. In addition, the “memory” should be interpreted broadly to encompass any electronic component that is capable of storing electronic information. The “memory” may refer to various types of processor-readable media such as random access memory (RAM), read-only memory (ROM), non-volatile random access memory (NVRAM), programmable read-only memory (PROM), erasable programmable read-only memory (EPROM), electrically erasable PROM (EEPROM), flash memory, magnetic or optical data storage, registers, etc. The memory is said to be in electronic communication with a processor if the processor can read information from and/or write information to the memory. The memory integrated with the processor is in electronic communication with the processor.

In addition, terms such as first, second, A, B, (a), (b), etc. used in the following examples are only used to distinguish certain components from other components, and the nature, sequence, order, etc. of the components are not limited by the terms.

In addition, in the following examples, if a certain component is stated as being “connected,” “combined” or “coupled” to another component, it is to be understood that there may be yet another intervening component “connected,” “combined” or “coupled” between the two components, although the two components may also be directly connected or coupled to each other.

In addition, as used in the following examples, “comprise” and/or “comprising” does not foreclose the presence or addition of one or more other elements, steps, operations, and/or devices in addition to the recited elements, steps, operations, or devices.

Hereinafter, various examples of the present disclosure will be described in detail with reference to the accompanying drawings.

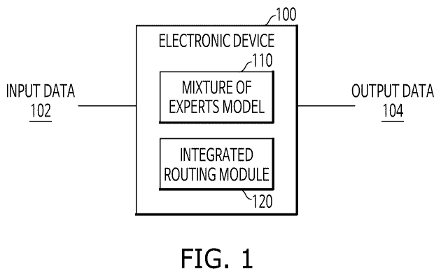

FIG. 1 illustrates, by way of example, an electronic device 100 for optimizing a mixture of experts model according to an example of the present disclosure. Referring to FIG. 1, the electronic device 100 for optimizing a mixture of experts model may include a mixture of experts (MoE) model 110 and an integrated routing module 120. The mixture of experts model 110 and the integrated routing module 120 may be included in a neural network processing unit (e.g., a neural network processor) that performs neural network operations. According to an example, the integrated routing module 120 may be implemented on hardware separate from the hardware on which the mixture of experts model 110 is implemented. The mixture of experts model 110 may include a machine learning model that divides an artificial intelligence (AI) model into separate sub-networks (e.g., experts). The sub-networks may be multiple expert networks (e.g., learners in learning process(es)) and may be used to divide a problem space into homogeneous regions.

The mixture of experts model 110 may select the most suitable expert unit (or expert network) among multiple expert units in accordance with input data 102, and may process the input data 102 using the selected expert unit to output output data 104. For example, rather than having the entire model process all data, the mixture of experts model 110 may activate only some expert units depending on the input. Accordingly, the computational efficiency of the model may be increased, and more refined predictions may be made for specific problems. However, because the mixture of experts model 110 uses an independent routing unit (or routing network) for each layer to select an expert unit to be activated, the routing unit enables each layer to select an optimal expert unit, yet the independent operation of each layer may cause additional computation overhead in inference, and overhead for loading the selected expert units into memory at each layer may also be high. To address this, the present disclosure optimizes the mixture of experts model 110 by using the integrated routing module 120 to predict in advance the expert units to be activated at each layer and to prefetch them.

The integrated routing module 120 may acquire the hidden state of the current layer of the mixture of experts model 110 (hereinafter referred to as the first layer) and an index of at least one next layer (hereinafter referred to as at least one second layer) following the current layer. Then, based on the hidden state of the first layer and the index of the at least one second layer, the integrated routing module 120 may predict at least one first expert unit to be activated in the at least one second layer. For example, the integrated routing module 120 may combine the result obtained by processing and/or transforming the hidden state of the first layer with the result of embedding the index of the at least one second layer as a unique vector, thereby predicting at least one first expert unit to be activated in the at least one second layer. Here, the integrated routing module 120 may include a neural network model for predicting the at least one first expert unit. For example, the integrated routing module 120 may employ a neural network structure such as a fully connected layer, an activation function (e.g., SiLU (sigmoid linear unit)), and a dropout layer.

Next, the integrated routing module 120 may prefetch the predicted at least one first expert unit. For example, before starting an operation for the at least one second layer, the integrated routing module 120 may load the predicted at least one first expert unit into the internal memory in advance. As a result, overhead from loading expert units may be reduced, memory access time may decrease, and inference speed may improve.

Then, the integrated routing module 120 may acquire the hidden state of a third layer, which is the last layer among the at least one second layer, and may acquire an index of at least one fourth layer following the third layer. Next, based on the hidden state of the third layer and the index of the at least one fourth layer, the integrated routing module 120 may predict at least one second expert unit to be activated in the at least one fourth layer. The integrated routing module 120 may then prefetch the predicted at least one second expert unit. For example, the integrated routing module 120 may repeatedly perform the process of predicting expert units in this manner up to the final layer of the mixture of experts model 110.

According to an example, the integrated routing module 120 may set a number of the at least one second layer (or at least one fourth layer) and a number of the at least one first expert unit (or at least one second expert unit) based on the structure of the mixture of experts model 110. For example, the integrated routing module 120 may set the number of layers to be predicted and the number of expert units to be selected based on the structure of the mixture of experts model 110. Thus, the integrated routing module 120 may be flexibly applied to various structures of the mixture of experts model 110. Here, the number of layers to be predicted may be a hyperparameter that determines the look-ahead range.

According to an example, a routing unit of the mixture of experts model 110 may acquire a hidden state of at least one second layer and, based on the hidden state of the at least one second layer, may select at least one third expert unit that is activated in the at least one second layer. For example, the routing unit in each layer of the mixture of experts model 110 may select, from among a plurality of expert units, at least one expert unit (e.g., at least one third expert unit) suitable for performing neural network operations on an input. In this instance, if the routing unit of the mixture of experts model 110 identifies, among the at least one third expert unit, an expert unit different from the prefetched at least one first expert unit, the routing unit may load the identified expert unit into an internal memory. For example, when the routing unit of the mixture of experts model 110 selects an expert unit other than an already loaded expert unit, the routing unit may additionally load the selected expert unit into the internal memory. In other words, if the prediction result from the integrated routing module 120 and the selection result from the routing unit of the mixture of experts model 110 differ, the target of prefetching may vary, and thus, the mixture of experts model 110 may include correction logic to compensate for this.

According to an example, the routing unit of the mixture of experts model 110 may acquire the hidden state of the at least one second layer and select at least one third expert unit that is activated in the at least one second layer based on the hidden state of the at least one second layer. For example, the routing unit at each layer of the mixture of experts model 110 may select at least one expert unit (e.g., at least one third expert unit) suitable for the neural network operation on the input among multiple expert units. In this case, the selection result of the routing unit at each layer of the mixture of experts model 110 may be utilized as ground truth for training the integrated routing module 120. That is, the integrated routing module 120 may train a neural network model for predicting the at least one first expert unit using the selection result of the at least one third expert unit. For example, whenever a token is generated, the mixture of experts model 110 may generate ground truth for training the integrated routing module 120, and because the integrated routing module 120 may have a structure independent of the mixture of experts model 110, the integrated routing module 120 may be trained online.

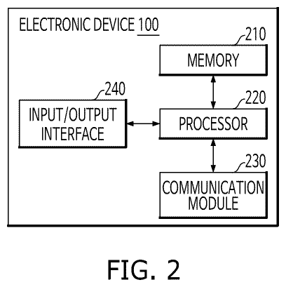

FIG. 2 is a diagram illustrating a configuration of the electronic device 100 according to an example of the present disclosure. Referring to FIG. 2, the electronic device 100 may include a memory 210, a processor 220, a communication module 230, and an input/output interface 240. However, the configuration of the electronic device 100 is not limited thereto. The electronic device 100 may omit at least one of the above components, or may further include at least one other component. For example, the electronic device 100 may further include a display.

The memory 210 may store various data used by at least one other component (e.g., the processor 220) of the electronic device 100. For example, the data may include software (or a program) and input or output data related thereto.

The memory 210 may include any non-transitory computer-readable recording medium. According to an example, the memory 210 may include a permanent mass storage device, such as a disk drive, an SSD (solid state drive), or a flash memory. In another example, a non-volatile mass storage device such as ROM, an SSD, a flash memory, or a disk drive, may be included in the electronic device 100 as a separate permanent storage device rather than as part of the memory 210. Further, the memory 210 may store an operating system and at least one program code (e.g., instructions related to optimizing a mixture of experts model installed and executed in the electronic device 100). Although FIG. 2 shows the memory 210 as a single memory for convenience of explanation, the memory 210 may include multiple memories and/or buffer memories.

Software components may be loaded into the memory 210 from a separate computer-readable recording medium. Such a separate computer-readable recording medium may include a medium directly connectable to the electronic device 100, for example, a floppy drive, a disk, a tape, a DVD/CD-ROM drive, or a memory card. In another example, the software components may be loaded into the memory 210 via the communication module 230, rather than from a computer-readable recording medium. For example, at least one program may be loaded into the memory 210 based on a computer program provided by developers or a file distribution system that distributes installation files for an application through the communication module 230.

The processor 220 may execute software (or programs) to control at least one other component (e.g., hardware or software components) of the electronic device 100 connected to the processor 220, and may perform various data processing or operations. According to an example, as at least a part of the data processing or operations, the processor 220 may load instructions or data received from another component (e.g., the communication module 230) into volatile memory, process the instructions or data stored in the volatile memory, and store resulting data in non-volatile memory.

The processor 220 may be configured to process computer-program instructions by performing basic arithmetic, logic, and input/output operations. Instructions may be provided to the processor 220 by the memory 210 or the communication module 230 in the electronic device 100 or by another external system. For example, the processor 220 may optimize the mixture of experts model by predicting at least one expert unit to be activated in at least one second layer based on the hidden state of the first layer of the mixture of experts model and an index of at least one second layer subsequent to the first layer, and by prefetching the predicted expert unit(s). Furthermore, the processor 220 may perform additional operations such as processing natural language by using the optimized mixture of experts model. Although FIG. 2 illustrates the processor 220 as a single processor for convenience, the processor 220 may include multiple processors. The processor 220 may also include a neural network processor.

The communication module 230 may support the establishment of a direct (e.g., wired) communication channel or a wireless communication channel between the electronic device 100 and an external electronic device and support communication over the established channel. For example, the communication module 230 may provide a function or configuration for the electronic device 100 and an external electronic device (e.g., a user terminal or a cloud server) to communicate via a network. By way of example, control signals, commands, or data provided under control of the processor 220 of the electronic device 100 may be transmitted to the external electronic device through the communication module 230 and the network, and then through the external electronic device's communication module.

The input/output interface 240 may be means for interfacing with input or output devices (not shown) that are connected to or included in the electronic device 100. For example, the input/output interface 240 may include at least one of a PCI express interface or an Ethernet interface. Although FIG. 2 shows the input/output interface 240 as a component separate from the processor 220, the input/output interface 240 may instead be included in the processor 220.

According to an example, the processor 220 may perform functions related to optimizing a mixture of experts (MoE) model. To perform such functions, the processor 220 may execute at least one computer-readable program included in the memory 210. Here, the at least one program may include instructions for acquiring the hidden state of a first layer of the mixture of experts model and an index of at least one second layer following the first layer, predicting at least one first expert unit to be activated in the at least one second layer based on the hidden state of the first layer and the index of the at least one second layer, and prefetching the predicted at least one first expert unit. For convenience of description, it may be said that the processor 220 performs functions related to optimizing a mixture of experts model when the processor 220 executes at least one program to do so. For example, saying that the at least one program includes instructions related to optimizing the mixture of experts model corresponds to describing that the processor 220 performs functions related to optimizing the mixture of experts model. In this case, the processor 220 may include a neural network processor that performs neural network operations.

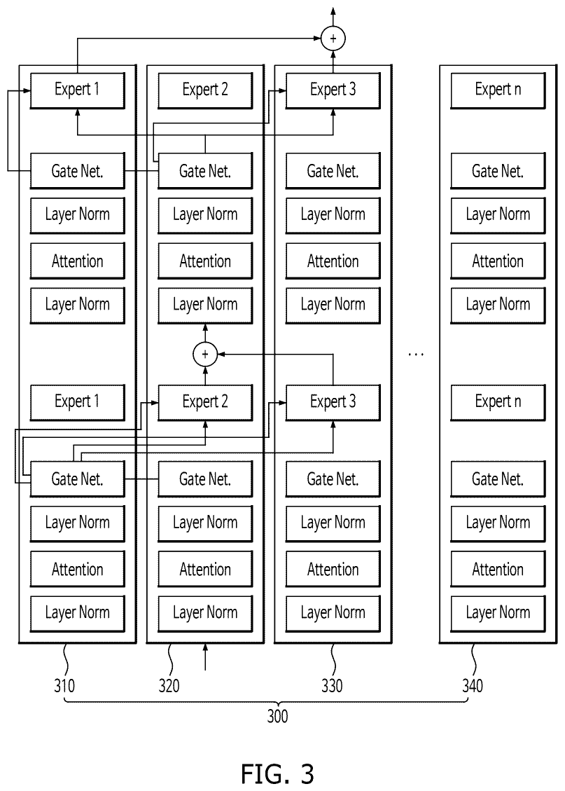

FIG. 3 is a conceptual diagram illustrating, by way of example, a mixture of experts model 300 according to an example of the present disclosure. Referring to FIG. 3, the mixture of experts model 300 (e.g., the mixture of experts model 110 of FIG. 1) may be composed of multiple neural network processing units 310, 320, 330, and 340. Each of the multiple neural network processing units 310, 320, 330, and 340 may correspond to a respective layer of the mixture of experts model 300 and may include a layer normalization unit (“Layer Norm” in FIG. 3), a self-attention unit (“Attention” in FIG. 3), a routing unit (“Gate Net.” in FIG. 3), and expert units (“Expert i” in FIG. 3, where i is a natural number). For example, the multiple neural network processing units 310, 320, 330, and 340 may include layer normalization units, self-attention units, and routing units that perform operations based on the same weights, while including independent expert units. That is, the layer normalization units, self-attention units, and routing units included in each of the multiple neural network processing units 310, 320, 330, and 340 may perform operations based on the same parameters, and the expert units included in each of the multiple neural network processing units 310, 320, 330, and 340 may perform operations based on at least partially different parameters. In other words, each of the multiple neural network processing units 310, 320, 330, and 340 may include expert units configured to perform specialized neural network operations.

The routing unit in each of the multiple neural network processing units 310, 320, 330, and 340 may determine which expert unit performs the operation on an input vector. In other words, the routing unit may multiply the input vector by a learnable weight matrix to calculate routing scores for each of the multiple expert units. The routing unit may then determine one or more expert units based on the routing scores. For example, the routing unit may use only the single expert unit with the highest routing score for the subsequent operation. In another example, the routing unit may select the top k (where k is a natural number of at least 2) expert units according to their routing scores, process the input vector through each selected expert unit, and generate an output vector based on the vectors produced by those expert units. In that case, if the output vector is generated via k expert units in the order of high routing scores, the neural network processing units 310, 320, 330, and 340 may produce their final output vector by performing a weighted sum of the k expert unit output vectors based on the routing scores.

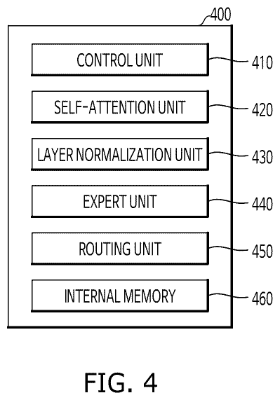

FIG. 4 is a diagram illustrating a configuration of a mixture of experts model 400 according to an example of the present disclosure. Referring to FIG. 4, the mixture of experts model 400 (e.g., the mixture of experts model 110 of FIG. 1 or the mixture of experts model 300 of FIG. 3) may include a control unit 410, a self-attention unit 420, a layer normalization unit 430, an expert unit 440, a routing unit 450, and an internal memory 460. However, the configuration of the mixture of experts model 400 is not limited thereto. The mixture of experts model 400 may omit at least one of the above components or may further include at least one other component. Each of the control unit 410, the self-attention unit 420, the layer normalization unit 430, the expert unit 440, and the routing unit 450 may be a semiconductor circuit in which multiple transistors are connected.

The control unit 410 may be a circuit composed of an arithmetic operation module that performs arithmetic operations (addition, subtraction, multiplication, division, etc.) and a logic operation module that performs logic operations (AND, OR, NOT, XOR, etc.). The control unit 410 may receive instructions, processor status signals, and/or clocks from the processor 220 of FIG. 2, and generate control signals for controlling the self-attention unit 420, the layer normalization unit 430, the expert unit 440, the routing unit 450, and the internal memory 460.

Each of the self-attention unit 420, the layer normalization unit 430, the expert unit 440, and the routing unit 450 may be configured to perform addition, multiplication, accumulation, or other functions needed for artificial neural network operations on data such as vectors or tensors. For example, each of the self-attention unit 420, the layer normalization unit 430, the expert unit 440, and the routing unit 450 may be a unit configured to perform multiplication and accumulation (MAC) operations required for artificial neural network operations on a per-workload basis.

The self-attention unit 420 may include an operation block that performs a self-attention mechanism. Self-attention is a concept that performs neural network operations on an input sequence to capture the importance of each token in that input sequence, and it may produce an output vector having the same dimension as the input vector.

The layer normalization unit 430 may normalize an input vector and output the normalized vector. The layer normalization unit 430 may calculate the mean and variance for each dimension of the input vector and normalize each element of the input based on the mean and variance.

The expert unit 440 may be a device that uses a feed-forward neural network to calculate an output vector from an input vector. The feed-forward neural network may have a multi-layer perceptron structure and may include at least one feed-forward layer and at least one activation layer. The activation function of the feed-forward neural network may include, for example, a ReLU (rectified linear unit) function. The weight matrix or learnable parameters used by the feed-forward neural network may be stored in the internal memory 460.

The routing unit 450 may be a device that determines which expert unit 440 is most suitable for the input vector. For example, the routing unit 450 may calculate a score for each expert unit 440 with respect to the input vector and determine the most suitable expert unit 440 based on the score. The routing unit 450 may perform multiplication operations using a weight matrix with respect to the input vector for a gating operation that determines the expert unit 440 corresponding to the input vector. Here, the weight matrix may be a matrix including at least one weight that is a learning target.

The internal memory 460 may be a memory used only for neural network operations. For example, the internal memory 460 may be a buffer memory and/or a cache memory configured to store weights, kernels, and/or feature maps required for the operations of each unit constituting the mixture of experts model 400.

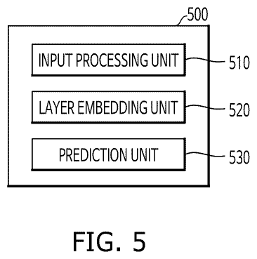

FIG. 5 is a diagram illustrating a configuration of an integrated routing module 500 according to an example of the present disclosure. Referring to FIG. 5, the integrated routing module 500 (e.g., the integrated routing module 120 of FIG. 1) may include an input processing unit 510, a layer embedding unit 520, and a prediction unit 530. However, the configuration of the integrated routing module 500 is not limited thereto. The integrated routing module 500 may omit at least one of the above components or may further include at least one other component.

The input processing unit 510 may process and/or transform the hidden state of any layer of the mixture of experts model (e.g., the mixture of experts model 110 of FIG. 1, the mixture of experts model 300 of FIG. 3, or the mixture of experts model 400 of FIG. 4).

The layer embedding unit 520 may embed the index of each layer of the mixture of experts model as a unique vector.

The prediction unit 530 may combine the output of the input processing unit 510 and the output of the layer embedding unit 520 to predict an expert unit (e.g., the expert unit 440 of FIG. 4) to be activated in at least one subsequent layer. The prediction unit 530 may use a neural network structure such as a fully connected layer, an activation function, or a dropout layer to perform the prediction.

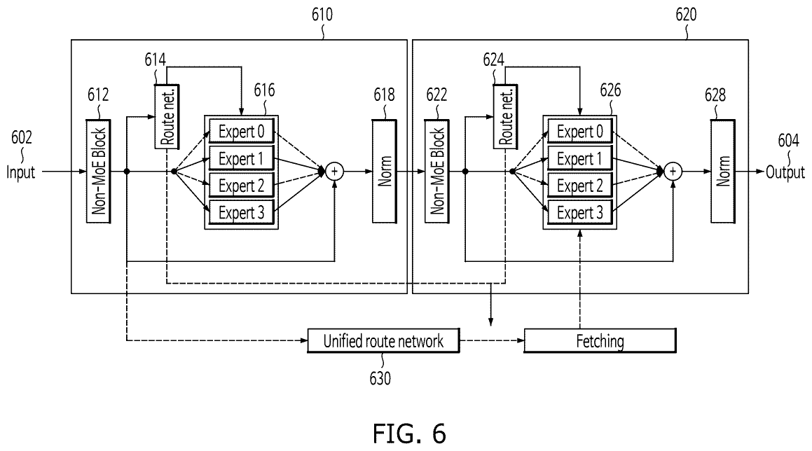

FIG. 6 is a conceptual diagram illustrating, by way of example, a mixture of experts model and an integrated routing module according to an example of the present disclosure. Referring to FIG. 6, the mixture of experts model (e.g., the mixture of experts model 110 of FIG. 1, the mixture of experts model 300 of FIG. 3, or the mixture of experts model 400 of FIG. 4) may combine multiple expert units (e.g., the expert unit 440 of FIG. 4) to select the most suitable expert unit for input data 602, process the input data 602, and output output data 604. Through the integrated routing module 630 (e.g., the integrated routing module 120 of FIG. 1 or the integrated routing module 500 of FIG. 5), by predicting and prefetching in advance which expert units will be activated in each layer of the mixture of experts model 610 and 620, the mixture of experts model may be optimized.

The integrated routing module 630 may acquire the hidden state of a first layer 610 of the mixture of experts model and an index of at least one second layer 620 following the first layer 610. Then, based on the hidden state of the first layer 610 and the index of the at least one second layer 620, the integrated routing module 630 may predict at least one first expert unit to be activated in the at least one second layer 620. Here, the integrated routing module 630 may include a neural network model for predicting the at least one first expert unit.

Next, the integrated routing module 630 may prefetch the predicted at least one first expert unit. For example, before starting operations for the at least one second layer 620, the integrated routing module 630 may load the predicted at least one first expert unit into the internal memory in advance.

The above expert unit prediction and prefetch operation may be repeated through the last layer of the mixture of experts model. For example (though not shown), the integrated routing module 630 may acquire the hidden state of a third layer, which is the last layer among the at least one second layer 620, and acquire an index of at least one fourth layer following the third layer. Then, based on the hidden state of the third layer and the index of the at least one fourth layer, the integrated routing module 630 may predict at least one second expert unit to be activated in the at least one fourth layer. The integrated routing module 630 may then prefetch the predicted at least one second expert unit.

According to an example, the integrated routing module 630 may set the number of layers to be predicted and the number of expert units to be selected based on the structure of the mixture of experts model.

According to an example, the routing unit 624 of at least one second layer 620 of the mixture of experts model may acquire the hidden state of the at least one second layer 620, and select at least one third expert unit that is activated in the at least one second layer 620 based on the hidden state of the at least one second layer 620. For example, the routing units 614, 624 in each layer 610, 620 of the mixture of experts model may select at least one expert unit among multiple expert units 616, 626 that is suitable for the neural network operation on the input. In this case, if an expert unit different from the at least one first expert unit that has been prefetched is identified among the at least one third expert unit, the routing unit 624 of the at least one second layer 620 of the mixture of experts model may load the identified expert unit into the internal memory. For example, if a layer's routing unit 614, 624 selects a different expert unit than the one already loaded, that unit is additionally loaded into the internal memory.

According to an example, a routing unit 614 or 624 of each layer 610 or 620 of the mixture of experts model may acquire the hidden state of the corresponding layer 610 or 620 and select at least one third expert unit that is activated in that layer based on the hidden state of that layer. For example, the routing unit 614 or 624 of each layer 610 or 620 in the mixture of experts model may select at least one third expert unit among multiple expert units 616 or 626 suitable for the neural network operation. In this case, the selection result of the routing unit 614 or 624 at each layer 610 or 620 of the mixture of experts model may be used as ground truth for training the integrated routing module 630. That is, the integrated routing module 630 may train a neural network model for predicting at least one first expert unit using the selection result of the at least one third expert unit. For example, whenever a token is generated, the mixture of experts model may generate ground truth for training the integrated routing module 630, and because the integrated routing module 630 may have a structure independent of the mixture of experts model, the integrated routing module 630 may be trained online. According to an example, the integrated routing module 630 may be implemented on hardware separate from the hardware on which the mixture of experts model is implemented.

In FIG. 6, Non-MoE Blocks 612 and 622 may represent components of the mixture of experts model other than the expert units 616 and 626 and the routing units 614 and 624 that select the expert units 616 and 626. The Non-MoE Blocks 612 and 622 may include, for example, at least one of a self-attention unit (e.g., the self-attention unit 420 of FIG. 4) or layer normalization units 618 and 628 (e.g., the layer normalization unit 430 of FIG. 4).

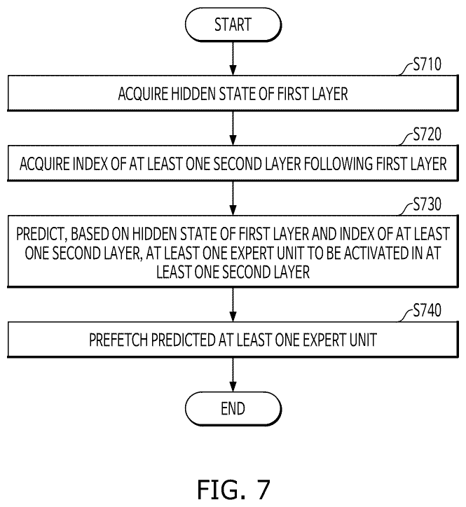

FIG. 7 is a diagram illustrating a method for optimizing a mixture of experts model according to an example of the present disclosure. Referring to FIG. 7, in step 710 (S710), a processor of an electronic device (e.g., the electronic device 100 of FIGS. 1 and 2) for optimizing a mixture of experts model (e.g., the mixture of experts model 110 of FIG. 1 or the mixture of experts model 300 of FIG. 3 or the mixture of experts model 400 of FIG. 4) may acquire the hidden state of a first layer. For example, an integrated routing module (e.g., the integrated routing module 120 of FIG. 1, the integrated routing module 500 of FIG. 5, or the integrated routing module 630 of FIG. 6) may acquire the hidden state of the current layer (i.e., the first layer) of the mixture of experts model.

In step 720 (S720), the processor may acquire an index of at least one second layer following the first layer. For example, the integrated routing module may acquire an index of at least one next layer (i.e., the at least one second layer) following the current layer.

In step 730 (S730), the processor may predict at least one expert unit to be activated in the at least one second layer based on the hidden state of the first layer and the index of the at least one second layer. For example, the integrated routing module may predict at least one expert unit to be activated in the at least one next layer based on the hidden state of the current layer and the index of the at least one next layer. Specifically, the integrated routing module may combine the result of processing and/or transforming the hidden state of the current layer with the result of embedding the index of the at least one next layer as a unique vector to predict at least one expert unit to be activated in the at least one next layer. Here, the integrated routing module may include a neural network model for predicting at least one expert unit. For example, the integrated routing module may employ a neural network structure such as a fully connected layer, an activation function (e.g., SiLU), or a dropout layer.

In step 740 (S740), the processor may prefetch the predicted at least one expert unit. For example, the integrated routing module may prefetch the predicted at least one expert unit. That is, before starting an operation for the at least one next layer, the integrated routing module may load in advance the predicted at least one expert unit into the internal memory.

The above-described operations of predicting and prefetching an expert unit (steps 710 through 740) may be repeated through the final layer of the mixture of experts model. For example, the integrated routing module may acquire the hidden state of a third layer, which is the last layer among the at least one second layer, and acquire an index of at least one fourth layer following the third layer. Then, based on the hidden state of the third layer and the index of the at least one fourth layer, the integrated routing module may predict at least one expert unit to be activated in the at least one fourth layer. The integrated routing module may then prefetch the predicted at least one expert unit.

According to an example, the integrated routing module may set the number of layers to be predicted and the number of expert units to be selected based on the structure of the mixture of experts model. Here, the number of layers to be predicted may be a hyperparameter that determines the prediction range.

According to an example, the routing unit of the mixture of experts model may acquire the hidden state of the at least one second layer, and select at least one expert unit that is activated in the at least one second layer based on the hidden state of the at least one second layer. For example, the routing unit in each layer of the mixture of experts model may select at least one expert unit suitable for the neural network operation for the input among a plurality of expert units. If an expert unit different from at least one prefetched expert unit is identified among the selected at least one expert unit, the routing unit may load the identified expert unit into the internal memory. For example, if a different expert unit is selected, in addition to the already loaded expert units, the routing unit of the mixture of experts model may also load that expert unit into the internal memory.

According to an example, the routing unit of the mixture of experts model may acquire the hidden state of the at least one second layer, and select at least one expert unit that is activated in the at least one second layer based on the hidden state of the at least one second layer. For example, at each layer of the mixture of experts model, the routing unit may select at least one expert unit among multiple expert units that is suitable for the neural network operation on the input. In this case, the selection result of the routing unit of each layer of the mixture of experts model may be used as ground truth for training the integrated routing module. That is, the integrated routing module may train a neural network model for predicting at least one expert unit by using the selection result of the routing unit. For example, whenever a token is generated, the mixture of experts model may generate ground truth for training the integrated routing module, and because the integrated routing module has a structure independent from the mixture of experts model, it may be trained online.

The flowchart and description above are merely examples and may be implemented differently in some examples. For example, in some examples, the order of respective steps may be changed, some steps may be repeatedly performed, some steps may be omitted, or some steps may be added.

The method described above may be provided as a computer program stored in a computer-readable recording medium for execution on a computer. The medium may be a type of medium that continuously stores a program executable by a computer, or temporarily stores the program for execution or download. In addition, the medium may be a variety of recording means or storage means having a single piece of hardware or a combination of several pieces of hardware, and is not limited to a medium that is directly connected to any computer system, and accordingly, may be present on a network in a distributed manner. An example of the medium includes a medium configured to store program instructions, including a magnetic medium such as a hard disk, a floppy disk, and a magnetic tape, an optical medium such as a CD-ROM and a DVD, a magnetic-optical medium such as a floptical disk, and a ROM, a RAM, a flash memory, etc. In addition, other examples of the medium may include an app store that distributes applications, a site that supplies or distributes various software, and a recording medium or a storage medium managed by a server.

The methods, operations, or techniques of the present disclosure may be implemented by various means. For example, these techniques may be implemented in hardware, firmware, software, or a combination thereof. Those skilled in the art will further appreciate that various illustrative logical blocks, modules, circuits, and algorithm steps described in connection with the disclosure herein may be implemented in electronic hardware, computer software, or combinations of both. To clearly illustrate this interchangeability of hardware and software, various illustrative components, blocks, modules, circuits, and steps have been described above generally in terms of their functionality. Whether such a function is implemented as hardware or software varies depending on design requirements imposed on the particular application and the overall system. Those skilled in the art may implement the described functions in varying ways for each particular application, but such implementation should not be interpreted as causing a departure from the scope of the present disclosure.

In a hardware implementation, processing units used to perform the techniques may be implemented in one or more ASICs, DSPs, digital signal processing devices (DSPDs), programmable logic devices (PLDs), field programmable gate arrays (FPGAs), processors, controllers, microcontrollers, microprocessors, electronic devices, other electronic units designed to perform the functions described in the present disclosure, computer, or a combination thereof.

Accordingly, various example logic blocks, modules, and circuits described in connection with the present disclosure may be implemented or performed with general purpose processors, DSPs, ASICs, FPGAs or other programmable logic devices, discrete gate or transistor logic, discrete hardware components, or any combination of those designed to perform the functions described herein. The general purpose processor may be a microprocessor, but in the alternative, the processor may be any related processor, controller, microcontroller, or state machine. The processor may also be implemented as a combination of computing devices, for example, a DSP and microprocessor, a plurality of microprocessors, one or more microprocessors associated with a DSP core, or any other combination of the configurations.

In the implementation using firmware and/or software, the techniques may be implemented with instructions stored on a computer-readable medium, such as random access memory (RAM), read-only memory (ROM), non-volatile random access memory (NVRAM), programmable read-only memory (PROM), erasable programmable read-only memory (EPROM), electrically erasable PROM (EEPROM), flash memory, compact disc (CD), magnetic or optical data storage devices, etc. The instructions may be executable by one or more processors, and may cause the processor(s) to perform certain aspects of the functions described in the present disclosure.

When implemented in software, the techniques may be stored on a computer-readable medium as one or more instructions or codes, or may be transmitted through a computer-readable medium. The computer-readable media include both the computer storage media and the communication media including any medium that facilitates the transmission of a computer program from one place to another. The storage media may also be any available media that may be accessible to a computer. By way of non-limiting example, such a computer-readable medium may include RAM, ROM, EEPROM, CD-ROM or other optical disk storage, magnetic disk storage or other magnetic storage devices, or any other media that can be used to transmit or store desired program code in the form of instructions or data structures and can be accessible to a computer. In addition, any connection is properly referred to as a computer-readable medium.

For example, if the software is sent from a website, server, or other remote sources using coaxial cable, fiber optic cable, twisted pair, digital subscriber line (DSL), or wireless technologies such as infrared, wireless, and microwave, the coaxial cable, the fiber optic cable, the twisted pair, the digital subscriber line, or the wireless technologies such as infrared, wireless, and microwave are included within the definition of the medium. The disks and the discs used herein include CDs, laser disks, optical disks, digital versatile discs (DVDs), floppy disks, and Blu-ray disks, where disks usually magnetically reproduce data, while discs optically reproduce data using a laser. The combinations described above should also be included within the scope of the computer-readable media.

The software module may reside in RAM memory, flash memory, ROM memory, EPROM memory, EEPROM memory, registers, hard disk, removable disk, CD-ROM, or any other form of storage medium known. An exemplary storage medium may be connected to the processor such that the processor may read or write information from or to the storage medium. Alternatively, the storage medium may be integrated into the processor. The processor and the storage medium may exist in the ASIC. The ASIC may exist in the user terminal. Alternatively, the processor and storage medium may exist as separate components in the user terminal.

Although the examples described above have been described as utilizing aspects of the currently disclosed subject matter in one or more standalone computer systems, aspects are not limited thereto, and may be implemented in conjunction with any computing environment, such as a network or distributed computing environment. Furthermore, the aspects of the subject matter in the present disclosure may be implemented in multiple processing chips or apparatus, and storage may be similarly influenced across a plurality of apparatus. Such apparatus may include PCs, network servers, and portable apparatus.

Although the present disclosure has been described in connection with some examples herein, various modifications and changes can be made without departing from the scope of the present disclosure, which can be understood by those skilled in the art to which the present disclosure pertains. In addition, such modifications and changes should be considered within the scope of the claims appended herein.

What is claimed is:

1. A method performed by an electronic device comprising at least one processor, the method comprising:
acquiring a hidden state of a first layer associated with a mixture of experts model;
acquiring an index of at least one second layer, associated with the mixture of experts model, following the first layer;
predicting, based on the hidden state of the first layer and the index of the at least one second layer, at least one first expert unit to be activated in the at least one second layer;
prefetching the predicted at least one first expert unit; and
outputting, based on the prefetching, a signal associated with adjustment of the mixture of experts model.

2. The method according to claim 1, further comprising:
acquiring a hidden state of a third layer, wherein the third layer is a last layer among the at least one second layer;
acquiring an index of at least one fourth layer, associated with the mixture of experts model, following the third layer;
predicting, based on the hidden state of the third layer and the index of the at least one fourth layer, at least one second expert unit to be activated in the at least one fourth layer; and
prefetching the predicted at least one second expert unit.

3. The method according to claim 1, further comprising setting, based on a structure of the mixture of experts model, a number of the at least one second layer and a number of the at least one first expert unit.

4. The method according to claim 1, wherein the predicting of the at least one first expert unit comprises predicting the at least one first expert unit using a neural network model.

5. The method according to claim 1, further comprising:
acquiring a hidden state of the at least one second layer;
selecting, based on the hidden state of the at least one second layer, at least one third expert unit that is activated in the at least one second layer; and
based on a certain expert unit different from the at least one first expert unit being identified among the at least one third expert unit, loading the certain expert unit into an internal memory of the electronic device.

6. The method according to claim 1, wherein the predicting of the at least one first expert unit is performed by an integrated routing module implemented on hardware separate from hardware on which the mixture of experts model is implemented.

7. The method according to claim 1, further comprising:
acquiring a hidden state of the at least one second layer;
selecting, based on the hidden state of the at least one second layer, at least one third expert unit that is activated in the at least one second layer; and
training a neural network model for predicting the at least one first expert unit using a selection result of the at least one third expert unit.

8. A non-transitory computer-readable medium storing computer-readable instructions that, when executed by at least one processor, cause an electronic device to:
acquire a hidden state of a first layer associated with a mixture of experts model;
acquire an index of at least one second layer, associated with the mixture of experts model, following the first layer;
predict, based on the hidden state of the first layer and the index of the at least one second layer, at least one first expert unit to be activated in the at least one second layer;
prefetch the predicted at least one first expert unit; and
output, based on the prefetching, a signal associated with adjustment of the mixture of experts model.

9. An electronic device comprising:
at least one processor, and
a memory storing computer-readable instructions that, when executed by the at least one processor, cause the electronic device to:
acquire a hidden state of a first layer associated with a mixture of experts model, wherein the mixture of experts model comprises a plurality of expert units configured to perform neural network operations;
acquire an index of at least one second layer, associated with the mixture of experts model, following the first layer;
predict, based on the hidden state of the first layer and the index of the at least one second layer, at least one first expert unit to be activated in the at least one second layer;
prefetch the predicted at least one first expert unit into an internal memory of the mixture of experts model; and
output, based on the prefetching, a signal associated with adjustment of the mixture of experts model.

10. The electronic device according to claim 9, wherein the computer-readable instructions, when executed by the at least one processor, cause the electronic device to:
acquire a hidden state of a third layer, wherein the third layer is a last layer among the at least one second layer;
acquire an index of at least one fourth layer, associated with the mixture of experts model, following the third layer;
predict, based on the hidden state of the third layer and the index of the at least one fourth layer, at least one second expert unit to be activated in the at least one fourth layer; and
prefetch the predicted at least one second expert unit into the internal memory.

11. The electronic device according to claim 9, wherein the computer-readable instructions, when executed by the at least one processor, cause the electronic device to set, based on a structure of the mixture of experts model, a number of the at least one second layer and a number of the at least one first expert unit.

12. The electronic device according to claim 9, further comprising a neural network model for predicting the at least one first expert unit.

13. The electronic device according to claim 9, wherein a routing unit of the mixture of experts model is configured to:
acquire a hidden state of the at least one second layer;
select, based on the hidden state of the at least one second layer, at least one third expert unit that is activated in the at least one second layer; and
based on a certain expert unit different from the at least one first expert unit being identified among the at least one third expert unit, load the certain expert unit into the internal memory.

14. The electronic device according to claim 9, wherein the at least one processor comprises an integrated routing module that is implemented on hardware separate from hardware on which the mixture of experts model is implemented.

15. The electronic device according to claim 9, wherein a routing unit of the mixture of experts model is configured to:
acquire a hidden state of the at least one second layer; and
select, based on the hidden state of the at least one second layer, at least one third expert unit that is activated in the at least one second layer, and
wherein the computer-readable instructions, when executed by the at least one processor, cause the electronic device to train a neural network model for predicting the at least one first expert unit using a selection result of the at least one third expert unit.

16. The electronic device according to claim 9, wherein the mixture of experts model further comprises:
a routing unit configured to select at least one expert unit, among the plurality of expert units, suitable for a particular neural network operation, and
the internal memory.
